(19) United States
(12) Patent Application Publication
(10) Pub. No.: US 2003/0018119 A1
(43) Pub. Date: Jan. 23, 2003

(54) Method and compositions for preventing the agglomeration of aqueous pigment dispersions

(76) Inventors: Moshe Frenkel, Jerusalem (IL); Jankiel Kimelblat, Ra`anana (IL)

Correspondence Address: Eitan, Pearl, Latzer & Cohen-Zedek, Suite 210, One Crystal Park, 2011 Crystal Drive, Arlington, VA, 22202-3709, US

(21) Appl. No.: 09/818,586

(22) Filed: Mar. 28, 2001

(51) Int. Cl. C08J 3/00

(52) U.S. Cl. 524/502

(57) ABSTRACT

The present invention provides a method of preventing pigment agglomeration upon the addition of an aqueous resin solution to an aqueous pigment dispersion. The present invention further provides a method of stabilizing a pigment dispersion upon the addition of an aqueous resin solution to an aqueous pigment dispersion. Pigment agglomeration is prevented and the pigment dispersion is stabilized by mixing butylated PVP with the pigment dispersion prior to the addition of the resin solution. The present invention further provides an aqueous ink-jet composition for use in aqueous-based ink-jet printers. The composition comprises water, butylated PVP, an aqueous pigment dispersion, a resin and a humectant. The present invention further provides a process for preparing said ink composition.

### FIELD OF THE INVENTION

The present invention generally relates to methods and compositions for stabilizing aqueous based inks. More specifically, the present invention relates the addition of an additive which prevents the agglomeration of aqueous pigment dispersions upon the addition of an aqueous resin solution to an aqueous pigment dispersion.

### BACKGROUND OF THE INVENTION

Ink-jet printing has experienced a significant increase in use in recent years displacing other printing methods due to reduced cost and improvements in print speed and print resolution. Additionally, ink-jet technology is well suited for high-resolution graphic images, particularly those produced using electronic printing systems. Such systems typically employ computer technology to create, modify, and store images, text, graphics and the like.

Ink-jet printers make use of liquid-based inks which are jetted onto a receptor, typically a sheet of paper or film, to produce an image. These liquid-based inks are either water-based or organic-solvent based, and typically comprise water or an organic-based solvent, dispersants, humectants to prevent tip drying, and colorants. Suitable colorants for ink-jet printers are dyes or pigments. By using four basic ink colors (black, yellow, cyan, and magenta) in various combinations and concentrations, high color gamut may be produced as part of the printed image.

Many of the inks that have been used in the past with ink-jet and other printers are primarily comprised of dyes contained within organic or water-based carrier liquids. Although such inks may offer satisfactory performance in applications such as home and office printers, the present trend for industrial applications is away from such systems. Dye-based inks have a few drawbacks, such as insufficient printing quality due to blurring, and poor light resistance. Consequently, dye-based inks tend to produce images that lack the light stability and durability required for outdoor and similarly demanding applications.

Additionally, the use of organic-based carrier liquids creates numerous environmental and material-handling complications. The printing industry has therefore sought inks that are primarily water-based, to thereby reduce or eliminate the problems associated with organic solvent-based inks.

Pigment-based inks, on the other hand, scarcely suffer from blurring, and consequently display excellent printing quality. As well, pigment-based inks are superior to dye-based inks in light resistance. Thus, the present trend is to use water-based pigment containing inks, which are environmentally safer, easier to handle, and are better suited for various industrial applications. Various commercial pigments are available for use with pigment-based inks. These typically comprise one or more pigmented color components dispersed in a water-based vehicle, and they usually also contain additives such as dispersing agents and other surfactants.

In order to meet the requirements of industrial applications such as abrasion resistance, adhesion to different substrates, water resistance and detergent resistance, it is often necessary to add polymers (resin) to the ink. After jetting the ink onto the substrate, the solvent dries out and the resin forms a film that, once completely dried, is not water-soluble, thus imparting the required properties to the printed image. By adding resins with different characteristics such as molecular weight, glass transition temperature (Tg), and acid value, it is possible to customize the ink for specific industrial applications, such as wall covering, cardboards, billboards, posters etc.

When preparing an ink-jet ink, generally the addition order of the components is as follows: a) water; b) humectants; c) pigment dispersion; d) resin; and e) additives. The addition of an aqueous resin solution to a dispersion of pigment in water causes in most cases a de-stabilization of the pigment dispersion system, which is observed as agglomeration. These agglomerates are not visible to the naked eye but can be readily identified with an optical microscope at 100× magnification and by a decrease in optical density on print.

Suitable pigment dispersions for ink-jet inks present very small particle size; generally the maximum particle size is smaller than 500 nm. The dispersions are made stable by means of addition of dispersing agents and surfactants that confer stability of the dispersion by steric and electrostatic effects, These materials are generally added during the pigment milling step of the manufacture. It is believed that the addition of resin solution to a pigment dispersion causes a migration of amounts of the stabilizing agents which results in the observed agglomeration.

Since ink-jet printers make use of very small jet nozzles (on the order of less than about 50 micrometers) to provide high resolution images, the resulting pigment agglomerations have a tendency to restrict or clog the printer heads. Once dried, the agglomerates are difficult to remove. One way to solve this problem is to remove the agglomerates by filtration, However, this causes a significant reduction in the ink's optical density.

The problem of pigment agglomeration seriously limits the practical use of pigment-based resin-containing inks. Consequently, there is an urgent need for a method of preventing pigment agglomeration upon the addition of an aqueous resin solution to an aqueous pigment dispersion during the process of forming aqueous pigment-based inks.

### SUMMARY OF THE INVENTION

The present invention relates to a method of preventing pigment agglomeration upon the addition of an aqueous resin solution to an aqueous pigment dispersion. The present invention further relates to a method of stabilizing a pigment dispersion upon the addition of an aqueous resin solution to an aqueous pigment dispersion. Pigment agglomeration is prevented and the pigment dispersion is stabilized by the addition of butylated polyvinylpyrrolidone (butylated PVP) to the pigment dispersion prior to addition of the resin solution. The present invention further relates to an aqueous inkjet composition for use in inkjet inks, and to a process of preparing said composition.

There is thus provided, in accordance with an embodiment of the present invention, a method of preventing pigment agglomeration upon the addition of an aqueous resin solution to an aqueous pigment dispersion, The method comprises the steps of mixing butylated PVP with the pigment dispersion, and adding the resin solution to the mixture of butylated PVP and pigment dispersion, thereby preventing pigment agglomeration, The resin an acrylic resin, a styrene acrylic resin, a carboxylated acrylic resin, or any combination thereof.

In one embodiment, the mixing step comprises the steps of preparing a water solution of butylated PVP, and adding the pigment dispersion to the water solution.

In one embodiment, the pigment dispersion is a black pigment dispersion. In another embodiment, the pigment dispersion is a yellow pigment dispersion. In yet another embodiment, the pigment dispersion is a cyan pigment dispersion. In yet another embodiment, the pigment dispersion is a magenta pigment dispersion.

In one embodiment, the concentration of butylated PVP is 0.5-2% by weight of the butylated PVP/pigment dispersion/resin/water mixture. In another embodiment, the concentration of butylated PVP is 1% by weight of the butylated PVP/pigment dispersion/resin/water mixture. In yet another embodiment, the concentration of butylated PVP is 2% by weight of butylated PVP/pigment dispersion/resin/water mixture.

In addition, there is thus provided, in accordance with an embodiment of the present invention, a method of stabilizing an aqueous pigment dispersion upon the addition of an aqueous resin solution to said pigment dispersion. The method comprises the steps of mixing butylated PVP with the pigment dispersion, and adding the resin solution to the mixture of butylated PVP and pigment dispersion, thereby stabilizing the pigment dispersion. The resin is an acrylic resin, a styrene acrylic resin, a carboxylated acrylic resin, or any combination thereof.

In one embodiment, the mixing step comprises the steps of preparing a water solution of butylated PVP, and adding the pigment dispersion to the water solution.

In one embodiment, the pigment dispersion is a black pigment dispersion. In another embodiment, the pigment dispersion is a yellow pigment dispersion. In yet another embodiment, the pigment dispersion is a cyan pigment dispersion. In yet another embodiment, the pigment dispersion is a magenta pigment dispersion.

In one embodiment, the concentration of butylated PVP is 0.5-2% by weight of the butylated PVP/pigment dispersion/resin/water mixture. In another embodiment, the concentration of butylated PVP is 1% by weight of the butylated PVP/pigment dispersion/resin/water mixture. In yet another embodiment, the concentration of butylated PVP is 2% by weight of the butylated PVP/pigment dispersion/resin/water mixture.

In addition, there is thus provided, in accordance with an embodiment of the present invention, a process for preparing an aqueous pigment-based ink. The process comprises the steps of preparing a water solution of butylated PVP, adding a humectant to the water solution, adding an aqueous pigment dispersion to the water solution, thereby preparing a mixture of butylated PVP pigment dispersion, and adding an aqueous resin solution to the mixture of butylated PVP and pigment dispersion. In one embodiment, The resin is an acrylic resin, a styrene acrylic resin, a carboxylated acrylic resin, or any combination thereof.

In one embodiment, the process further comprises the step of adding a reagent for preventing bacterial growth. In one embodiment, the process further comprises the step of adding a surfactant.

In one embodiment, the pigment dispersion is a black pigment dispersion. In another embodiment, the pigment dispersion is a yellow pigment dispersion. In yet another embodiment, the pigment dispersion is a cyan pigment dispersion. In yet another embodiment, the pigment dispersion is a magenta pigment dispersion.

In one embodiment, the concentration of butylated PVP is 0.5-2% by weight of the butylated PVP/pigment dispersion/resin/water mixture. In another embodiment, the concentration of butylated PVP is 1% by weight of the butylated PVP/pigment dispersion/resin/water mixture, In yet embodiment, the concentration of butylated PVP is 2% by weight of the butylated PVP/pigment dispersion/resin/water mixture.

In addition, there is thus provided, in accordance with one embodiment of the present invention, an aqueous ink composition for use in ink-jet printing. The composition comprises water, butylated PVP, an aqueous pigment dispersion, a resin, and a humectant. The resin is an acrylic resin, a styrene acrylic resin, a carboxylated acrylic resin, or any combination thereof. In one embodiment, the composition further comprises a reagent for preventing bacterial growth. In one embodiment, the composition further comprises a surfactant.

In one embodiment, the pigment dispersion is a black pigment dispersion. In another embodiment, the pigment dispersion is a yellow pigment dispersion. In yet another embodiment, the pigment dispersion is a cyan pigment dispersion. In yet another embodiment, the pigment dispersion is a magenta pigment dispersion.

In one embodiment, the concentration of butylated PVP is 0.5-2% by weight of the composition. In another embodiment, the concentration of butylated PVP is 1% by weight of the composition. In yet embodiment, the concentration of butylated PVP is 2% by weight of the composition.

### BRIEF DESCRIPTION OF THE DRAWINGS

The present invention will be understood and appreciated more fully from the following detailed description taken in conjunction with the appended drawings in which:

FIG. 1 shows pictures of combinations of pigment dispersions and polymer resins as seen at 400× magnification under an optical microscope.

FIG. 1A: black pigment dispersion Cab-O-Jet 300 and Joncryl HPD 671 resin.

FIG. 1B: black pigment dispersion Cab-O-Jet 200 and Joncryl HPD 671 resin.

FIG. 2 shows pictures of a combination of a black pigment dispersion Hostafine Black T (3%) and Joncryl HPD 671 resin (10%) as seen at 400× magnification under an optical microscope.

FIG. 2A: without butylated PVP (Antaron P904).

FIG. 2B: with butylated PVP (Antaron P904) unfiltered.

FIG. 2C: with butylated PVP (Antaron P904) filtered.

FIG. 2D: 3% resin and no butylated PVP.

FIG. 3 shows pictures of a mixture of a magenta pigment dispersion Hostafine Rubine F6B and Joncryl HPD 671 resin, as seen at 400× magnification under an optical microscope.

FIG. 3A: without butylated PVP (Antaron P904).

FIG. 3B: with butylated PVP (Antaron P904).

FIG. 4 shows pictures of a mixture of a cyan pigment dispersion Liojet Cyan K7088-A2 and Joncryl HPD 671 resin, as seen at 400× magnification under an optical microscope.

FIG. 4A: without butylated PVP (Antaron P904). FIG. 4B: with butylated PVP (Antaron P904).

### DETAILED DESCRIPTION OF THE PRESENT INVENTION

The present invention provides a method of preventing pigment agglomeration upon the addition of an aqueous resin solution to an aqueous pigment dispersion during the process of forming aqueous pigment-based inks. Pigment agglomeration is prevented by mixing butylated PVP with the pigment dispersion prior to the addition of the resin solution.

The present invention further provides a method for stabilizing an aqueous pigment dispersion upon the addition of an aqueous resin solution to the pigment dispersion. The pigment dispersion is stabilized by mixing butylated PVP with the pigment dispersion prior to the addition of the resin solution.

The present invention further relates to an ink-jet composition for use in ink-jet printers. The composition comprises water, butylated PVP; an aqueous pigment dispersion; a resin and a humectant. The present invention further provides a process for preparing said composition.

When preparing an aqueous pigment-based ink-jet ink, generally the addition order of the components is as follows: a) water, b) humectants; c) pigment dispersion; d) resin; and e) additives. The addition of an aqueous resin solution to a dispersion of pigment in water causes in most cases a de-stabilization of the pigment system which is observed as agglomeration under the microscope. These agglomerates are not visible to the naked eye, but can be readily identified with an optical microscope at 100x magnification and by a decrease in optical density on print.

Various combinations of commercially available aqueous pigment dispersions and polymer resins were tested. Applicants determined that in most cases, the addition of an aqueous resin solution onto an aqueous dispersion of pigment causes pigment agglomeration. In a few cases, however, pigment agglomeration was not observed, demonstrating that pigment agglomeration does not always occur. The effect was particularly observed when aqueous resin solutions with Acid value above 110 were used. Acid value is defined herein as the number of mg of KOH which are required to neutralize 1 g. of solid resin. The determination is made by titrating the sample in hot 95% ethanol using phenolphthalein as an indicator.

Aqueous Pigment Dispersions:

Some representative manufacturers and their respective product lines of pigment dispersions for water-based ink-jet inks are listed in Table 1 below:

TABLE 1

| | Pigment dispersions for water-based ink-jet |
|---|---|
| Manufacturer | inks |
| Ciba Specialty Chemicals | Microlith WA |
| | 1. Black: Microlith C-WA |
| Cabot Corporation | Cab-O-Jet |
| | Black: Cab-O-Jet 300 |
| | Black: Cab-O-Jet 200 |
| Orient | Bonjet |
| | Black: Bonjet CW-1 |
| | Cyan: Bonjet Cyan WMBE-6 |
| | Magenta: Bonjet Magenta SMP-4-0302 |
| | Yellow: Bonjet Yellow WMYE-5 |
| Clariant | Hostafine |
| | Black: Hostafine Black T |
| | Cyan: Hostafine Blue B2G |
| | Magenta: Hostafine Rubine F6B |
| | Yellow: Hostafine Yellow HR |
| Toyo | Liojet |
| | Black: Liojet Black 9122-A1 |
| | Cyan: Liojet Cyan K7088-A2 |
| | Magenta: Liojet Magenta L4092 |
| | Yellow: Liojet Yellow L2116-A1 |
| Bayer | Levanyl |
| | Black: Levanyl Black A-SF |

Resins:

Table 2 lists different resins and their respective properties. Water solutions of these resins were tested with different aqueous pigment dispersions.

TABLE 2

| | | Molecular | | |
|---|---|---|---|---|
| Resin | | Weight | | |
| solution | Type | (approx.) | Acid value | Manufacturer |
| Joncryl HPD | Styrene | 17250 | 214 | Johnson Polymer |
| 671 | acrylic | | | |
| Joncryl 683 | Styrene | 9200 | 150 | Johnson Polymer |
| | acrylic | | | |
| Joncryl 678 | Styrene | 8500 | 215 | Johnson Polymer |
| | acrylic | | | |
| Joncryl 586 | Styrene | 4200 | 110 | Johnson Polymer |
| | acrylic | | | |
| Joncryl 611 | Styrene | 7700 | 53 | Johnson Polymer |
| | acrylic | | | |
| Carboset GA | Styrene | 6500 | 215 | B. F. Goodrich |
| 1160 | acrylic | | | |
| Carboset GA | Styrene | 1500 | 200 | B. F. Goodnch |
| 1161 | acrylic | | | |
| Carboset GA | Styrene | 1500 | 220 | B. F. Goodrich |
| 1162 | acrylic | | | |
| Surcol 441 | Carboxylated | | 130 | Allied Colloids |
| | acrylic | | | |
| Jonrez | Acrylic | 7000 | 206 | Westvaco |
| IJ4650 | | | | |

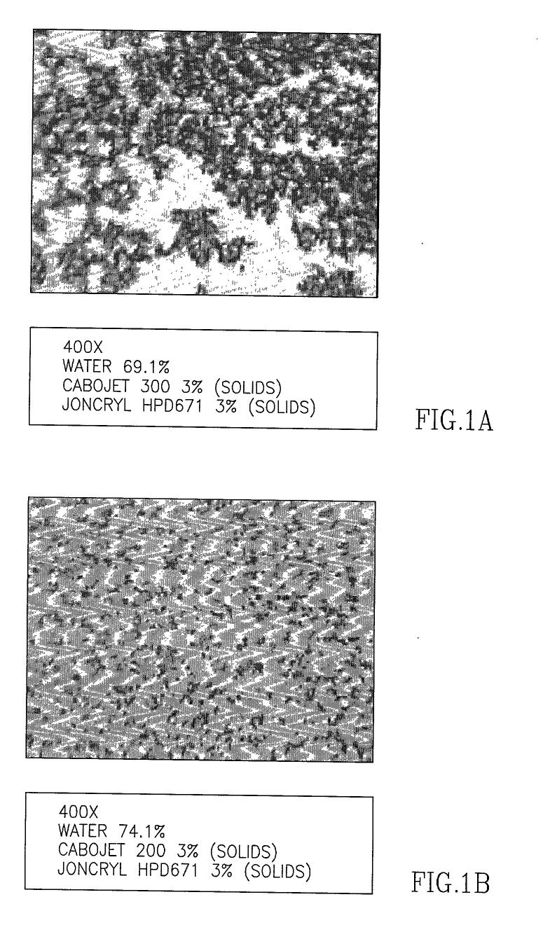

Reference is now made to FIG. 1, which depicts pictures of mixtures of pigment dispersions and polymer resins as seen under an optical microscope. These mixtures were prepared by adding an aqueous resin solution to an aqueous pigment dispersion, FIG. 1A illustrates pigment agglomeration when a resin sold by Johnson polymer under the tradename Joncryl HPD 671 (3% solids content) is added to a black pigment dispersion sold by CABOT Corporation under the trade name Cab-O-Jet 300 (3% solids content) as seen at 400× magnification. Pigment agglomerates are seen. FIG. 1B illustrates pigment agglomeration when a resin sold by Johnson polymer under the tradename Joncryl HPD 671 (3% solids content) is added to a black pigment dispersion sold by CABOT Corporation under the trade name Cab-O-Jet 200 (3% solids content) as seen at 400× magnification. Again, pigment agglomerates are seen.

Changing the addition order of the components, i.e., adding pigment dispersion to the resin solution, does not prevent the pigment agglomeration (data not shown).

In the search for a solution to the problem of pigment agglomeration, Applicants have surprisingly and unexpectedly identified a reagent, namely butylated PVP, which in most cases is very effective at preventing pigment agglomeration when an aqueous resin solution is added to an aqueous pigment dispersion. When butylated PVP is mixed with the pigment dispersion prior to the addition of the resin solution, pigment agglomeration is prevented or reduced, as will be shown in detail below.

Butylated PVP is a commercial product and is available from various suppliers. A preferred butylated PVP for the present invention is sold by International Specialty Products (ISP) under the tradenames Antaron P904 (in Europe ) and Ganex P904 (in the US). Since butylated PVP is supplied in a powder form, it has to be dissolved in water prior to the addition of pigment dispersion. Since the ink-jet inks of the present invention are water-based, the dissolution of butylated PVP may be performed using the water present in the formulation followed by addition of the remaining components.

Thus, in accordance with one embodiment of the present invention, butylated PVP is dissolved in water, and to the solution an aqueous pigment dispersion is added, followed by an aqueous resin solution. However, it is apparent to a person skilled in the art that other embodiments exist, for example, a pigment dispersion may first be mixed with water, followed by the addition of a water solution of butylated PVP, then the resin solution.

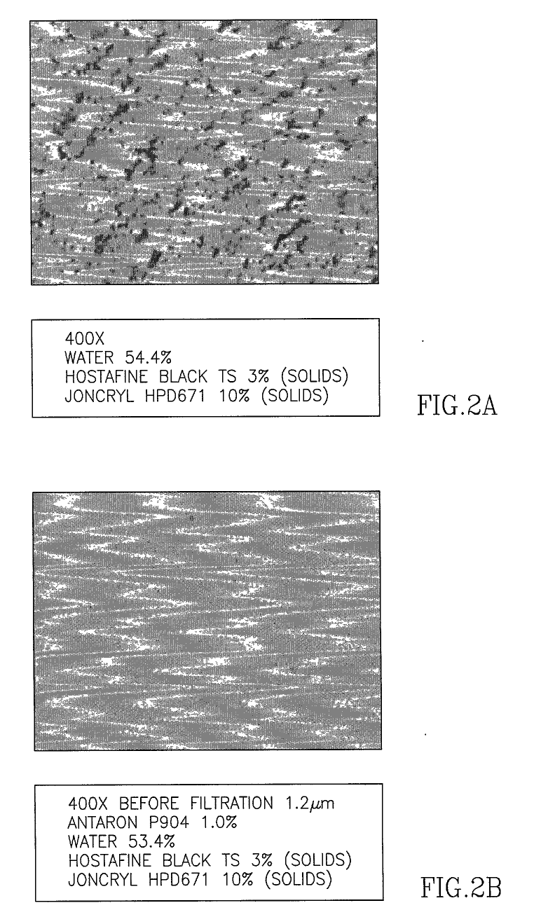

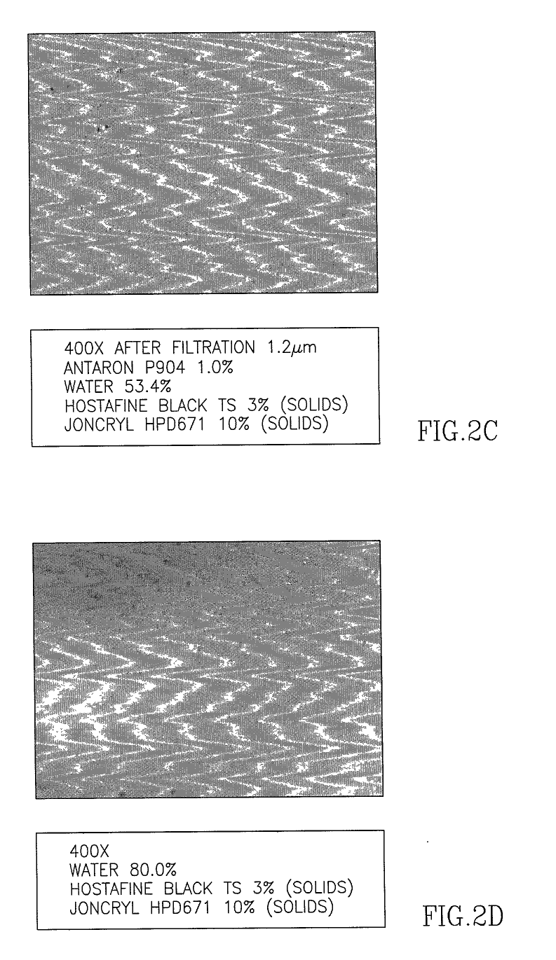

Reference is now made to FIG. 2, which depicts pictures of a mixture of a black pigment dispersion sold under the tradename Hostafine Black T (3% solids content), manufactured by Clariant Corp, and Joncryl HPD 671 resin (10% solids content) as seen under an optical microscope at 400X magnification. FIG. 2A is a picture of a mixture Hostafine Black T and Joncryl HPD 671 resin, without addition of butylated PVP (Antaron P904). Pigment agglomerates are seen. FIG. 2B is a picture of the same mixture after addition of 1% Antaron P904 without filtration, and FIG. 2C is a picture of the same mixture after filtration with a 1,2 μm filter. Experimentally, a water solution of Antaron P904 is prepared, and to it is added an aqueous pigment dispersion followed by the addition of the resin solution, As can be seen, pigment agglomeration is reduced dramatically as a result of the addition of Antaron P904. It should be noted that the degree of pigment agglomeration is dependent on the concentration of the resin. As seen in FIG. 2D, addition of 3% Joncryl HPD 671 resin to Hostafine Black (3%) does not result in a significant formation of pigment agglomerates. Typically, about 7% resin is the minimum amount required in order to provide the ink with desired properties, such as abrasion resistance and adhesion.

In addition to black pigment dispersions, colored pigment dispersions, namely cyan, magenta and yellow pigment dispersions were tested, and the ability of Antaron P904 to prevent pigment agglomeration of these pigments was assayed. It was established that a) pigment agglomeration does not always occur with these colored pigments; and b) Antaron P904 is able to prevent pigment agglomeration in most cases where pigment agglomeration occurs.

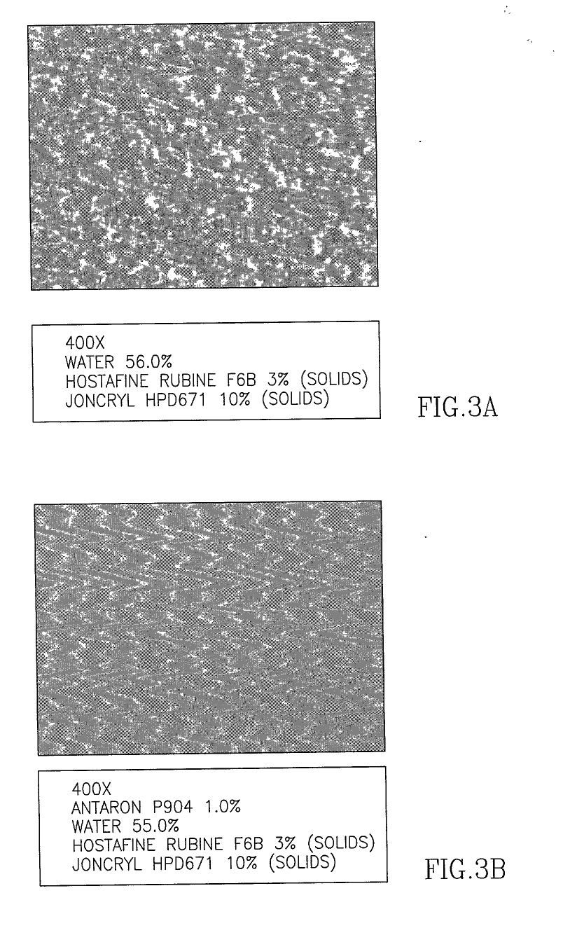

Reference is now made to FIG. 3, which depicts pictures of a mixture of a magenta pigment dispersion sold under the tradename Hostafine Rubine F6B (3% solids content), manufactured by Clariant Corp, and Joncryl HPD 671 resin (10% solids content) as seen under an optical microscope at 400× magnification, FIG. 3A is a picture of a mixture Hostafine Rubine F6B and Joncryl HPD 671 resin, without addition of butylated PVP (Antaron P904). Pigment agglomerates are seen. FIG. 3B is a picture of the same mixture after addition of 1% Antaron P904. As can be seen, pigment agglomeration is reduced dramatically as a result of the addition of Antaron P904.

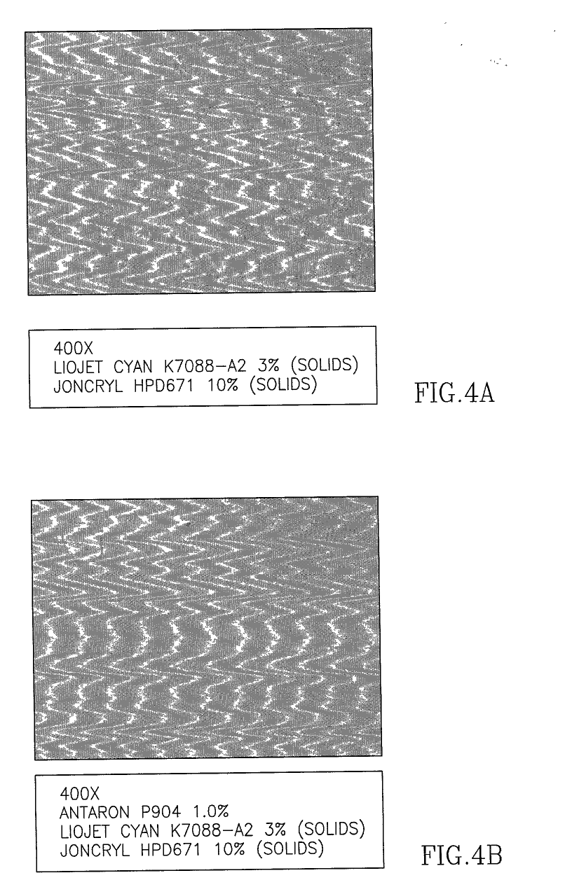

Reference is now made to FIG. 4, which depicts pictures of a mixture of a cyan pigment dispersion sold under the tradename of a cyan pigment dispersion Liojet Cyan K7088-A2 (3% solids content), manufactured by Clariant Corp, and Joncryl HPD 671 resin (10% solids content) as seen under an optical microscope at 400× magnification. FIG. 4A is a picture of a Liojet Cyan K7088-A2 and Joncryl HPD 671 resin, without addition of butylated PVP (Antaron P904). Pigment agglomerates are seen. FIG. 4B is a picture of the same mixture after addition of 1% Antaron P904. As can be seen, pigment agglomeration is reduced dramatically as a result of the addition of Antaron P904.

It should be noted that Antaron P904 was not able to prevent pigment agglomeration of a mixture of a cyan pigment dispersion sold under the tradename Hostafine Blue B2G (3% solids content), manufactured by Clariant Corp, and Joncryl HPD 671 (data not shown).

The Figures shown hereinabove illustrate the ability of Antaron P904 to prevent pigment agglomeration in most cases when an aqueous resin solution is added to an aqueous pigment dispersion. Additional examples will be discussed in the Examples which follow.

In accordance with one embodiment of the present invention, there is provided a method of preventing pigment agglomeration upon the addition of an aqueous resin solution to an aqueous pigment dispersion. The method comprises mixing butylated PVP with the pigment dispersion; and adding therein solution. In one embodiment, a water solution of butylated PVP is prepared, and the pigment dispersion is added to the water solution, followed by the resin solution.

In accordance with another embodiment of the present invention. there is provided a method of stabilizing a pigment agglomeration upon the addition of an aqueous resin solution to an aqueous pigment dispersion. The method comprises mixing butylated PVP with the pigment dispersion; and adding the resin solution. In one embodiment, a water solution of butylated PVP is prepared, and the pigment dispersion is added to the water solution, followed by the resin solution.

The choice of the concentration of butylated PVP is empirical, and should be determined based on the specific combination of the pigment dispersion and the resin. For example, in one embodiment, the concentration of butylated PVP is 0.5-2% by weight. In another embodiment, the concentration of butylated PVP is 1% by weight. In yet another embodiment, the concentration of butylated PVP is 2% by weight. The weight percent is defined herein as the weight of solid butylated PVP divided by the total solid weight of the butylated PVP/pigment dispersion/resin/water mixture.

Examples of aqueous pigment dispersions which are suitable for the inks of the present invention are described above. In addition, examples of resins which are suitable for the inks of the present invention are described above. Generally, any type of resin is applicable, preferably an acrylic resin, a styrene acrylic resin, a carboxylated acrylic resin, or any combination thereof.

The addition of an aqueous resin solution to a pigment dispersion is part of the process of forming aqueous-based inks for ink-jet printers. Thus, it is desirable to add butylated PVP as an additive when these ink-jet inks are formulated, in order to stabilize the inks and prevent pigment agglomeration. Accordingly, another embodiment of the present invention provides a process of forming an aqueous-based pigment-based ink for ink-jet printers. The process comprises the steps of preparing a water solution of butylated PVP, adding a humectant to the water solution, adding an aqueous pigment dispersion to the water solution, thereby preparing a mixture of the butylated PVP pigment dispersion, and adding an aqueous resin solution to said mixture of butylated PVP and pigment dispersion.

Furthermore, another embodiment of the present invention provides an ink composition for use in ink-jet printers. The composition comprises: water, butylated PVP, an aqueous pigment dispersion, a resin solution and a humectant.

It is well known that humectants, including alkanediols such as ethylene glycol, can be added to an ink to prevent drying out or crusting of the ink. Such is commonly done, for example, in continuous jet inks. The amounts used in such inks do not exceed about 5 weight percent, since humectants are highly viscous and the viscosity of continuous jet inks cannot exceed about 2.0 centipoise to be effective. Thus, according to one embodiment of the present invention, a humectant is added to the pigment dispersion containing butylated PVP, prior to the addition of resin. A preferred humectant for the present invention is ethylene glycol. Other suitable humectants are the following alkanediols:1,2-propanediol; and 1,3-propanediol.

In addition, the inks of the present invention may optionally contain surfactants. Examples of surfactants are non-ionic surfactant such as fluorinated surfactants, for example fluorinated alkyl esters, siloxane surfactant such as silicone surface additives sold by Byk Chemie under the Tradenames BYK 345, BYK 333 and BYK 348, Tegowet 250 (Tego), Tegowet 260 (Tego), Surfynol 104PA (Air Products), and Dynol 604 (Air Products).

In one embodiment, the composition of the present invention further comprises a reagent for preventing bacterial growth (Biocide). Examples of Biocides are Proxel BD20 (Avecia), Proxel TN (Avecia), Proxel GXL (Avecia), Nipacide CBX (Nipa Biocides), and Nipacide CFX2 (Nipa Biocides).

The above discussion provides a factual basis for a method of preventing pigment agglomeration and stabilizing an aqueous pigment dispersion using butylated PVP. The methods used with and the utility of the present invention can be shown by the following non-limiting examples and accompanying table. This section is set forth to aid in an understanding of the invention but is not intended and should not be construed to limit in any way the invention as set forth in the claims that follow thereafter.

### EXAMPLES

The examples bellow represent trials with different aqueous pigment dispersions and aqueous resin solutions and demonstrate the ability of Antaron P904 to prevent, in most cases, the formation of pigment agglomerates.

The amount of resin added in the following examples is typically 7% (solids content) or greater. This amount is generally the minimum required to provide the desired properties, such as abrasion resistance and adhesion.

### Examples 1-3

Examples 1-3 demonstrate the formation of pigment agglomerates when different resins from Johnson Polymer with Acid values above 110 mg KOH/g, are added to a black pigment dispersion from Orient (Bonjet Black CW-1). Pigment agglomeration is observed in all three examples.

### Example #1

A liquid consisting of:

| Ingredient | Weight (%) |
|---|---|
| Water | 44.6 |
| Black pigment dispersion sold under the trade name | 25.0 |
| Bonjet Black CW-1 manufactured by Orient Chemical | Total solids = 5% |
| Industries Ltd. | |
| Resin solution sold under the trade name Joncryl HPD | 30.4 |
| 671 manufactured by Johnson Polymer | Total solids = 7% |

was prepared in the following mixing order:

Water

Bonjet Black CW-1

Joncryl HPD 671

### Example #2

A liquid consisting of:

| Ingredient | Weight (%) |
|---|---|
| Water | 33.8 |
| Black pigment dispersion sold under the trade name | 25.0 |
| Bonjet Black CW-1 manufactured by Orient Chemical | Total solids = 5% |
| Industries Ltd. | |
| Resin solution sold under the trade name Joncryl 683 | 41.2 |
| manufactured by Johnson Polymer | Total solids = 7% |

was prepared in the following mixing order:

Water

Bonjet Black CW-1

Joncryl 683

### Example #3

A liquid consisting of:

| Ingredient | Weight (%) |
|---|---|
| Water | 50.0 |
| Black pigment dispersion sold under the trade name | 25.0 |
| Bonjet Black CW-1 manufactured by Orient Chemical | Total solids = 5% |
| Industries Ltd. | |
| Resin solution sold under the trade name Joncryl 678 | 25.0 |
| manufactured by Johnson Polymer | Total solids = 7% |

was prepared in the following mixing order:

Water

Bonjet Black CW-1

Joncryl HPD 678

### Example #4

In Example 4, an aqueous resin solution from Johnson Polymer, with Acid value of 110 mg KOH/g is added to the same pigment dispersion from Orient (Bonjet Black CW-1). No pigment agglomeration is observed This example demonstrates that the effect of pigment agglomeration is primarily observed when resin solutions with Acid value above 110 mg KOH/g are used.

A liquid consisting of:

| Ingredient | Weight (%) |
|---|---|
| Water | 36.1 |
| Black pigment dispersion sold under the trade name | 25.0 |
| Bonjet Black CW-1 manufactured by Orient Chemical | Total solids = 5% |
| Industries Ltd. | |
| Resin solution sold under the trade name Joncryl 586 | 38.9 |
| manufactured by Johnson Polymer | Total solids = 7% |

was prepared in the following mixing order:

Water

Bonjet Black CW-1

Joncryl HPD 586

### Examples 5-7

### Example #5

A liquid consisting of:

| Ingredient | Weight (%) |
|---|---|
| Water | 36.3 |
| Black pigment dispersion sold under the trade name | 33.3 |
| Cab-O-Jet 300 manufactured by CABOT Corporation | Total solids = 5% |
| Resin solution sold under the trade name Joncryl | 30.4 |
| HPD671 manufactured by Johnson Polymer | Total solids = 7% |

was prepared in the following mixing order:

Water

Bonjet Black CW-1

Joncryl HPD 586

### Example #6

A liquid consisting of:

| Ingredient | Weight (%) |
|---|---|
| Water | 25.5 |
| Black pigment dispersion sold under the trade name | 33.3 |
| Cab-O-Jet 300 manufactured by CABOT Corporation | Total solids = 5% |
| Resin solution sold under the trade name Joncryl 683 | 41.2 |
| manufactured by Johnson Polymer | Total solids = 7% |

was prepared in the following mixing order:

Water

Cab-O-Jet 300

Joncryl 683

### Example 7

A liquid consisting of:

| Ingredient | Weight (%) |
|---|---|
| Water | 41.7 |
| Black pigment dispersion sold under the trade name | 33.3 |
| Cab-O-Jet 300 manufactured by CABOT Corporation | Total solids = 5% |
| Resin solution sold under the trade name Joncryl 678 | 25.0 |
| manufactured by Johnson Polymer | Total solids = 7% |

was prepared in the following mixing order:

Water

Cab-O-Jet 300

Joncryl 678

### Example #8

In Example 8, the same resin used in Example 4 (Acid value=110) is added to the same pigment dispersion from CABOT. No pigment agglomeration is observed. This example further demonstrates that the effect of pigment agglomeration is primarily observed when resin solutions with Acid value above 110 mg KOH/g are used,

| Ingredient | Weight (%) |
|---|---|
| Water | 27.8 |
| Black pigment dispersion sold under the trade name | 33.3 |
| Cab-O-Jet 300 manufactured by CABOT Corporation | Total solids = 5% |
| Resin solution sold under the trade name Joncryl 586 | 38.9 |
| manufactured by Johnson Polymer | Total solids = 7% |

was prepared in the following mixing order:

Water

Cab-O-Jet 300

Joncryl 586

### Examples 9-11

Examples 9-11 describe the addition of resins from BF Goodrich with high Acid values to a black pigment dispersion from Orient. Pigment agglomeration occurs in all three examples.

### Example #9

A liquid consisting of:

| Ingredient | Weight (%) |
|---|---|
| Water | 50.0 |
| Black pigment dispersion sold under the trade name | 25.0 |
| Bonjet Black CW-1 manufactured by Orient Chemical | Total solids = 5% |
| Industries Ltd. | |
| Resin solution sold under the trade name Carboset | 25.0 |
| GA1160 manufactured by B F Goodrich | Total solids = 7% |

was prepared in the following mixing order:

Water

Bonjet Black CW-1

Carboset GA 1160

### Example #10

A liquid consisting of:

| Ingredient | Weight (%) |
|---|---|
| Water | 55.0 |
| Black pigment dispersion sold under the trade name | 25.0 |
| Bonjet Black CW-1 manufactured by Orient Chemical | Total solids = 5% |
| Industries Ltd. | |
| Resin solution sold under the trade name Carboset | 20.0 |
| GA1161 manufactured by B F Goodrich | Total solids = 7% |

was prepared in the following mixing order:

Water

Bonjet Black CW-1

Carboset GA 161

### Example #11

A liquid consisting of:

| Ingredient | Weight (%) |
|---|---|
| Water | 55.0 |
| Black pigment dispersion sold under the trade name | 25.0 |
| Bonjet Black CW-1 manufactured by Orient Chemical | Total solids = 5% |
| Industries Ltd. | |
| Resin solution sold under the trade name Carboset | 20.0 |
| GA1162 manufactured by B F Goodrich | Total solids = 7% |

was prepared in the following mixing order:

Water

Bonjet Black CW-1

Carboset GA1162

### Examples 12-14

Examples 12-14 describe the addition of resins from BF Goodrich with high Acid values to a black pigment dispersion from CABOT. Pigment agglomeration is observed in all three examples.

### Example #12

A liquid consisting of:

| Ingredient | Weight (%) |
|---|---|
| Water | 41.7 |
| Black pigment dispersion sold under the trade name | 33.3 |
| Cab-O-Jet 300 manufactured by CABOT Corporation | Total solids = 5% |
| Resin solution sold under the trade name Carboset | 25.0 |
| GA1160 manufactured by B F Goodrich | Total solids = 7% |

was prepared in the following mixing order:

Water

Cab-O-Jet 300

Carboset GA 160

### Example #13

A liquid consisting of:

| Ingredient | Weight (%) |
|---|---|
| Water | 46.7 |
| Black pigment dispersion sold under the trade name | 33.3 |
| Cab-O-Jet 300 manufactured by CABOT Corporation | Total solids = 5% |
| Resin solution sold under the trade name Carboset | 20.0 |
| GA1161 manufactured by B F Goodrich | Total solids = 7% |

was prepared in the following mixing order:

Water

Cab-O-Jet 300

Carboset GA1161

### Example #14

A liquid consisting of:

| Ingredient | Weight (%) |
|---|---|
| Water | 46.7 |
| Black pigment dispersion sold under the trade name | 33.3 |
| Cab-O-Jet 300 manufactured by CABOT Corporation | Total solids = 5% |
| Resin solution sold under the trade name Carboset | 20.0 |
| GA1162 manufactured by B F Goodrich | Total solids = 7% |

was prepared in the following mixing order:

Water

Cab-O-Jet 300

Carboset GA1162

### Examples 15-18

In Examples 15-18, an aqueous resin solution from Johnson Polymer sold under the name Joncryl HPD671 is added to black pigment dispersions from different manufacturers. With the exception of Example 17 where a pigment dispersion from Ciba is used, all the other pigment dispersions presented pigment agglomeration. These examples show that pigment agglomeration occurs in some but not all resin/pigment combinations.

### Example #15

A liquid consisting of:

| Ingredient | Weight (%) |
|---|---|
| Water | 44.6 |
| Black pigment dispersion sold under the trade name | 25.0 |
| Cab-O-Jet 200 manufactured by CABOT Corporation | Total solids = 5% |
| Resin solution sold under the trade name Joncryl | 30A |
| HPD671 manufactured by Johnson Polymer | Total solids = 7% |

was prepared in the following mixing order:

Water

Cab-O-Jet 200

Joncryl HPD671

### Example #16

A liquid consisting of:

| Ingredient | Weight (%) |
|---|---|
| Water | 52.9 |
| Black pigment dispersion sold under the trade name | 16.7 |
| Hostafine Black T manufactured by Clariant Corp. | Total solids = 5% |
| Resin solution sold under the trade name Joncryl | 30.4 |
| HPD671 manufactured by Johnson Polymer | Total solids = 7% |

was prepared in the following mixing order:

Water

Hostafine Black T

Joncryl HPD671

### Example #17

A liquid consisting of:

| Ingredient | Weight (%) |
|---|---|
| Water | 49.6 |
| Black pigment dispersion sold under the trade name | 20.0 |
| Microlith Black C-WA manufactured by Ciba | Total solids = 5% |
| Specialties | |
| Resin solution sold under the trade name Joncryl | 30.4 |
| HPD671 manufactured by Johnson Polymer | Total solids = 7% |

was prepared in the following mixing order:

Water

Microlith Black C-WA

Joncryl HPD671

### Example #18

A liquid consisting of:

| Ingredient | Weight (%) |
|---|---|
| Water | 51.7 |
| Black pigment dispersion sold under the trade name | 17.9 |
| Levanyl Black A-SF manufactured by Bayer | Total solids = 5% |
| Resin solution sold under the trade name Joncryl | 30.4 |
| HPD671 manufactured by Johnson Polymer | Total solids = 7% |

was prepared in the following mixing order:

Water

Levanyl Black A-SF

Joncryl HPD671

### Examples 19-25

In Examples 19-25 attempts to stabilize the black pigment dispersion from Orient, are made by adding different materials to water prior to the addition of pigment dispersion and high Acid value resin solution (same as Example 1). The following materials are tested:

### Example #19

Resin solution with Acid value 110 mg KOH/g sold under the trade name JonCryl 586 manufactured by Johnson Polymer, at 2% solids content. Result: pigment agglomeration.

A liquid consisting of:

| Ingredient | Weight (%) |
|---|---|
| Water | 33.5 |
| Resin solution sold under the trade name Joncryl 586 | 11.1 |
| manufactured by Johnson Polymer | Total solids = 2% |
| Black pigment dispersion sold under the trade name | 25.0 |
| Bonjet Black CW-1 manufactured by Orient Chemical | Total solids = 5% |
| Industries Ltd. | |
| Resin solution sold under the trade name Joncryl | 30.4 |
| HPD671 manufactured by Johnson Polymer | Total solids = 7% |

was prepared in the following mixing order:

Water

Joncryl 586

Bonjet Black OW-1

Joncryl HPD671

### Example #20

Same resin solution as Example 19, at 5% solids content. Result: pigment agglomeration.

A liquid consisting of:

| Ingredient | Weight (%) |
|---|---|
| Water | 16.8 |
| Resin solution sold under the trade name Joncryl 586 | 27.8 |
| manufactured by Johnson Polymer | Total solids = 2% |
| Black pigment dispersion sold under the trade name | 25.0 |
| Bonjet Black CW-1 manufactured by Orient Chemical | Total solids = 5% |
| Industries Ltd. | |
| Resin solution sold under the trade name Joncryl | 30.4 |
| HPD671 manufactured by Johnson Polymer | Total solids = 7% |

was prepared in the following mixing order:

Water

Joncryl 586

Bonjet Black CW-1

Joncryl HPD671

### Example #21

PVP (PVP-K30 average molecular weight: 58,000) at 2% solids content. Result: pigment agglomeration.

A liquid consisting of:

| Ingredient | Weight (%) |
|---|---|
| Water | 34.6 |
| Polyvinyl pyrrolidone PVP K-30 manufactured by ISP | 10.0 |
| 20% solution in water | Total solids = 2% |
| Black pigment dispersion sold under the trade name | 25.0 |
| Bonjet Black CW-1 manufactured by Orient Chemical | Total solids = 5% |
| Industries Ltd. | |
| Resin solution sold under the trade name Joncryl | 30.4 |
| HPD671 manufactured by Johnson Polymer | Total solids = 7% |

was prepared in the following mixing order:

Water

Polyvinyl pyrrolidone PVP K-30

Bonjet Black CW-1

Joncryl HPD671

### Example #22

PVP (PVP-K90 average molecular weight: 1,300,000) at 2% solids content. Result: pigment agglomeration.

A liquid consisting of:

| Ingredient | Weight (%) |
|---|---|
| Water | 24.6 |
| Polyvinyl pyrrolidone PVP K-90 manufactured by ISP | 20.0 |
| 10% solution in water | Total solids = 2% |
| Black pigment dispersion sold under the trade name | 25.0 |
| Bonjet Black CW-1 manufactured by Orient Chemical | Total solids = 5% |
| Industries Ltd. | |
| Resin solution sold under the trade name Joncryl | 30.4 |
| HPD671 manufactured by Johnson Polymer | Total solids = 7% |

was prepared in the following mixing order:

Water

Polyvinyl pyrrolidone PVP K-90

Bonjet Black CW-1

Joncryl HPD671

### Example #23

PVP (PVP-K15 average molecular weight: 8,000) at 2% solids content. Result: pigment agglomeration.

A liquid consisting of:

| Ingredient | Weight (%) |
|---|---|
| Water | 34.6 |
| Polyvinyl pyrrolidone PVP K-15 manufactured by ISP | 10.0 |
| 20% solution in water | Total solids = 2% |
| Black pigment dispersion sold under the trade name | 25.0 |
| Bonjet Black CW-1 manufactured by Orient Chemical | Total solids = 5% |
| Industries Ltd. | |
| Resin solution sold under the trade name Joncryl | 30.4 |
| HPD671 manufactured by Johnson Polymer | Total solids = 7% |

was prepared in the following mixing order:

Water

Polyvinyl pyrrolidone PVP K-15

Bonjet Black CW-1

Joncryl HPD671

### Example #24

N-methyl pyrrolidone at a concentration of 2%. Results pigment agglomeration.

A liquid consisting of:

| Ingredient | Weight (%) |
|---|---|
| Water | 42.6 |
| N-methyl pyrrolidone | 2.0 |
| Black pigment dispersion sold under the trade name | 25.0 |
| Bonjet Black CW-1 manufactured by Orient Chemical | Total solids = 5% |
| Industries Ltd. | |
| Resin solution sold under the trade name Joncryl | 30.4 |
| HPD671 manufactured by Johnson Polymer | Total solids = 7% |

was prepared in the following mixing order:

Water

N-methyl pyrrolidone

Bonjet Black CW-1

Joncryl HPD671

### Example #25

t-Octylphenoxypoly-ethoxyethanol (Triton X-100) at a concentration of 1%. Result: pigment agglomeration.

A liquid consisting of:

| Ingredient | Weight (%) |
|---|---|
| Water | 43.6 |
| t-Octylphenoxypoly-ethoxyethanol sold under the trade | 1.0 |
| name Triton X-100 manufactured by Union Carbide | |
| Black pigment dispersion sold under the trade name | 25.0 |
| Bonjet Black CW-1 manufactured by Orient Chemical | Total solids = 5% |
| Industries Ltd. | |
| Resin solution sold under the trade name Joncryl | 30.4 |
| HPD671 manufactured by Johnson Polymer | Total solids = 7% |

was prepared in the following mixing order;

Water

Triton X-100

Bonjet Black CW-1

Joncryl HPD671

### Example #26

In Example 26 a resin with an Acid value of 130 mg KOH/g is added to a black pigment dispersion from Orient. Pigment agglomeration is observed.

A liquid consisting of:

| Ingredient | Weight (%) |
|---|---|
| Water | 36.1 |
| Black pigment dispersion sold under the trade name | 25.0 |
| Bonjet Black CW-1 manufactured by Orient Chemical | Total solids = 5% |
| Industries Ltd. | |
| Resin solution sold under the trade name Surcol 441 | 38.9 |
| manufactured by Allied Colloids | Total solids = 7% |

was prepared in the following mixing order:

Water

Bonjet Black CW-1

Surcol 441

### Example #27

In Example 27 the same resin from Example 26 is added to a black pigment dispersion from CABOT. Pigment agglomeration is observed.

A liquid consisting of:

| Ingredient | Weight (%) |
|---|---|
| Water | 27.8 |
| Black pigment dispersion sold under the trade name | 33.3 |
| Cab-O-Jet 300 manufactured by CABOT Corporation | Total solids = 5% |
| Resin solution sold under the trade name Surcol 441 | 38.9 |
| manufactured by Allied Colloids | Total solids = 7% |

was prepared in the following mixing order:

Water

Cab-O-Jet 300

Surcol 441

### Example #28

In Example 28 Antaron P904 is dissolved in water at a concentration of 2% (from the total formulation) and to this solution the black pigment dispersion and the resin solution from Example 1 are added. No pigment agglomeration is observed. This example demonstrates the ability of Antaron P904 to prevent pigment agglomeration.

A liquid consisting of:

| Ingredient | Weight (%) |
|---|---|
| Water | 42.6 |
| Butylated polyvinylpyrralidone sold under the trade | 2.0 |
| name Antaron P-904 manufactured by ISP | |
| Black pigment dispersion sold under the trade name | 25.0 |
| Bonjet Black CW-1 manufactured by Orient Chemical | Total solids = 5% |
| Industries Ltd. | |
| Resin solution sold under the trade name Joncryl | 30.4 |
| HPD671 manufactured by Johnson Polymer | Total solids = 7% |

was prepared in the following mixing order:

Antaron P-904

Water

Bonjet Black CW-1

Joncryl HPD671

### Examples 29-34

In Examples 29-34 a solution of Antaron P904 at a concentration of 1% (from the total formulation) is prepared and to it a black pigment dispersion from Orient is added. Then resin solutions with different Acid values are added (a different resin per Example). No pigment agglomeration is observed in any of the Examples. These examples further demonstrate the ability of Antaron P904 to prevent pigment agglomeration.

### Example #29

A liquid consisting of:

| Ingredient | Weight (%) |
|---|---|
| Water | 49.0 |
| Butylated polyvinylpyrrolidone sold under the trade | 1.0 |
| name Antaron P-904 manufactured by ISP | |
| Black pigment dispersion sold under the trade name | 25.0 |
| Bonjet Black CW-1 manufactured by Orient Chemical | Total solids = 5% |
| Industries Ltd. | |
| Resin solution sold under the trade name Joncryl 678 | 25.0 |
| manufactured by Johnson Polymer | Total solids = 7% |

was prepared in the following mixing order:

Antaron P-904

Water

Bonjet Black CW-1

Joncryl 678

### Example #30

A liquid consisting of:

| Ingredient | Weight (%) |
|---|---|
| Water | 35.1 |
| Butylated polyvinylpyrrolidone sold under the trade | 1.0 |
| name Antaron P-904 manufactured by ISP | |
| Black pigment dispersion sold under the trade name | 25.0 |
| Bonjet Black CW-1 manufactured by Orient Chemical | Total solids = 5% |
| Industries Ltd. | |
| Resin solution sold under the trade name Joncryl 586 | 38.9 |
| manufactured by Johnson Polymer | Total solids = 7% |

was prepared in the following mixing order:

Antaron P-904

Water

Bonjet Black CW-1

Joncryl 586

### Example #31

A liquid consisting of:

| Ingredient | Weight (%) |
|---|---|
| Water | 32.8 |
| Butylated polyvinylpyrrolidone sold under the trade | 1.0 |
| name Antaron P-904 manufactured by ISP | |
| Black pigment dispersion sold under the trade name | 25.0 |
| Bonjet Black CW-1 manufactured by Orient Chemical | Total solids = 5% |
| Industries Ltd. | |
| Resin solution sold under the trade name Joncryl 683 | 41.2 |
| manufactured by Johnson Polymer | Total solids = 7% |

was prepared in the following mixing order:

Antaron P-904

Water

Bonjet Black CW-1

Joncryl 683

### Example #32

A liquid consisting of:

| Ingredient | Weight (%) |
|---|---|
| Water | 49.0 |
| Butylated polyvinylpyrrolidone sold under the trade | 1.0 |
| name Antaron P-904 manufactured by ISP | |
| Black pigment dispersion sold under the trade name | 25.0 |
| Bonjet Black CW-1 manufactured by Orient Chemical | Total solids = 5% |
| Industries Ltd. | |
| Resin solution sold under the trade name Carboset | 25.0 |
| GA1160 manufactured by B F Goodrich | Total solids = 7% |

was prepared in the following mixing order:

Antaron P-904

Water

Bonjet Black CW-1

Carboset GA1160

### Example #33

A liquid consisting of:

| Ingredient | Weight (%) |
|---|---|
| Water | 54.0 |
| Butylated polyvinylpyrrolidone sold under the trade | 1.0 |
| name Antaron P-904 manufactured by ISP | |
| Black pigment dispersion sold under the trade name | 25.0 |
| Bonjet Black CW-1 manufactured by Orient Chemical | Total solids = 5% |
| Industries Ltd. | |
| Resin solution sold under the trade name Carboset | 20.0 |
| GA1161 manufactured by B F Goodrich | Total solids = 7% |

was prepared in the following mixing order:

Antaron P-904

Water

Bonjet Black CW-1

Carboset GA1161

### Example #34

A liquid consisting of:

| Ingredient | Weight (%) |
|---|---|
| Water | 54.0 |
| Butylated polyvinylpyrrolidone sold under the trade | 1.0 |
| name Antaron P-904 manufactured by ISP | |
| Black pigment dispersion sold under the trade name | 25.0 |
| Bonjet Black CW-1 manufactured by Orient Chemical | Total solids = 5% |
| Industries Ltd. | |
| Resin solution sold under the trade name Carboset | 20.0 |
| GA1162 manufactured by B F Goodrich | Total solids = 7% |

was prepared in the following mixing order:

Antaron P-904

Water

Bonjet Black CW-1

Carboset GA1162

### Examples 35-39

In Examples 35-39 a solution of Antaron P904 at a concentration of 1% (from the total formulation) is prepared and to it different black pigment dispersions are added, followed by the addition of the same resin used in Example 1, except for example #35 which uses the resin Surcol 441. Except for example 37, pigment agglomeration is observed in all the examples. These examples demonstrate that Antaron P-904 is not able to prevent pigment agglomeration in all cases.

### Example #35

Pigment agglomeration is observed.

A liquid consisting of:

| Ingredient | Weight (%) |
|---|---|
| Water | 35.1 |
| Butylated polyvinylpyrrolidone sold under the trade | 1.0 |
| name Antaron P-904 manufactured by ISP | |
| Black pigment dispersion sold under the trade name | 25.0 |
| Bonjet Black CW-1 manufactured by Orient Chemical | Total solids = 5% |
| Industries Ltd. | |
| Resin solution sold under the trade name Surcol 441 | 38.9 |
| manufactured by Allied Colloids | Total solids = 7% |

was prepared in the following mixing order:

Antaron P-904

Water

Bonjet Black CW-1

Surcol 441

### Example #36

Pigment agglomeration is observed.

A liquid consisting of:

| Ingredient | Weight (%) |
|---|---|
| Water | 35.3 |
| Butylated polyvinylpyrrolidone sold under the trade | 1.0 |
| name Antaron P-904 manufactured by ISP | |
| Black pigment dispersion sold under the trade name | 33.3 |
| Cab-O-Jet 300 manufactured by CABOT Corporation | Total soilds 5% |
| Resin solution sold under the trade name Joncryl | 30.4 |
| HPD671 manufactured by Johnson Polymer | Total solids = 7% |

was prepared in the following mixing order:

Antaron P-904

Water

Cab-O-Jet 300

Joncryl HPD671

### Example #37

No pigment agglomeration.

A liquid consisting of:

| Ingredient | Weight (%) |
|---|---|
| Water | 51.9 |
| Butylated polyvinylpyrrolidone sold under the trade | 1.0 |
| name Antaron P-904 manufactured by ISP | |
| Black pigment dispersion sold under the trade name | 16.7 |
| Hostafine Black T manufactured by Clariant Corp. | Total solids = 5% |
| Resin solution sold under the trade name Joncryl | 30.4 |
| HPD671 manufactured by Johnson Polymer | Total solids = 7% |

was prepared in the following mixing order:

Antaron P-904

Water

Hostafine Black T

Joncryl HPD671

### Example #38:

Pigment agglomeration is observed.

A liquid consisting of:

| Ingredient | Weight (%) |
|---|---|
| Water | 50.7 |
| Butylated polyvinylpyrrolidone sold under the trade | 1.0 |
| name Antaron P-904 manufactured by ISP | |
| Black pigment dispersion sold under the trade name | 17.9 |
| Levanyl A-SF manufactured by Bayer | Total solids = 5% |
| Resin solution sold under the trade name Joncryl | 30.4 |
| HPD671 manufactured by Johnson Polymer | Total solids = 7% |

was prepared in the following mixing order:

Antaron P-904

Water

Levanyl A-SF

Joncryl HPD671

### Example #39

Pigment agglomeration is observed.

A liquid consisting of:

| Ingredient | Weight (%) |
|---|---|
| Water | 43.6 |
| Butylated polyvinylpyrrolidone sold under the trade | 1.0 |
| name Antaron P-904 manufactured by ISP | |
| Black pigment dispersion sold under the trade name | 25.0 |
| Cab-O-Jet 200 manufactured by CABOT Corporation | Total solids = 5% |
| Resin solution sold under the trade name Joncryl | 30.4 |
| HPD671 manufactured by Johnson Polymer | Total solids = 7% |

was prepared in the following mixing order:

Antaron P-904

Water

Cab-O-Jet 200

Joncryl HPD671

### EXAMPLES 40-43

In Examples 40-43 solutions of Antaron P904 at different concentrations are prepared in order to determine the minimum effective concentration. It is demonstrated that for concentrations less than 0.5%, Antaron P904 is not effective in preventing pigment agglomeration.

### Example #40

Pigment agglomeration is observed.

A liquid consisting of:

| Ingredient | Weight (%) |
|---|---|
| Water | 44.55 |
| Butylated polyvinylpyrrolidone sold under the trade | 0.05 |
| name Antaron P-904 manufactured by ISP | |
| Black pigment dispersion sold under the trade name | 25.0 |
| Bonjet Black CW-1 manufactured by Orient Chemical | Total solids = 5% |
| Industries Ltd. | |
| Resin solution sold under the trade name Joncryl | 30.4 |
| HPD671 manufactured by Johnson Polymer | Total solids = 7% |

was prepared in the following mixing order:

Antaron P-904

Water

Bonjet Black CW-1

Joncryl HPD671

### Example #41

Pigment agglomeration is observed.

A liquid consisting of:

| Ingredient | Weight (%) |
|---|---|
| Water | 44.5 |
| Butylated polyvinylpyrrolidone sold under the trade | 0.1 |
| name Antaron P-904 manufactured by ISP | |
| Black pigment dispersion sold under the trade name | 25.0 |
| Bonjet Black CW-1 manufactured by Orient Chemical | Total solids = 5% |
| Industries Ltd. | |
| Resin solution sold under the trade name Joncryl | 30.4 |
| HPD671 manufactured by Johnson Polymer | Total solids = 7% |

was prepared in the following mixing order:

Antaron P-904

Water

Bonjet Black CW-1

Joncryl HPD671

### Example #42

Pigment agglomeration is observed.

A liquid consisting of:

| Ingredient | Weight (%) |
|---|---|
| Water | 44.35 |
| Butylated polyvinylpyrrolidone sold under the trade | 0.25 |
| name Antaron P-904 manufactured by ISP | |
| Black pigment dispersion sold under the trade name | 25.0 |
| Bonjet Black CW-1 manufactured by Orient Chemical | Total solids = 5% |
| Industries Ltd. | |
| Resin solution sold under the trade name Joncryl | 30.4 |
| HPD671 manufactured by Johnson Polymer | Total solids = 7% |

was prepared in the following mixing order:

Antaron P-904

Water

Bonjet Black OW-1

Joncryl HPD671

### Example #43

No pigment agglomeration.

A liquid consisting of:

| Ingredient | Weight (%) |
|---|---|
| Water | 44.1 |
| Butylated polyvinylpyrrolidone sold under the trade | 0.5 |
| name Antaron P-904 manufactured by ISP | |
| Black pigment dispersion sold under the trade name | 25.0 |
| Bonjet Black CW-1 manufactured by Orient Chemical | Total solids = 5% |
| Industries Ltd. | |
| Resin solution sold under the trade name Joncryl | 30.4 |
| HPD671 manufactured by Johnson Polymer | Total solids = 7% |

was prepared in the following mixing order:

Antaron P-904

Water

Bonjet Black CW-1

Joncryl HPD671

Colored Pigments

Examples 44-53 and 56-58 test the ability of Antaron P904 to prevent pigment agglomeration of cyan, yellow and magenta pigments from various manufacturers. These examples demonstrate that: a) pigment agglomeration does not always occur with these colored pigments: and b) Anataron P904 is able to prevent pigment agglomeration in some but not all cases.

### Examples 44-45

In Example 44 the same resin solution from Example 1 is added to a cyan pigment dispersion resulting in the formation of agglomerates. In this case, the addition of Antaron P904, described in Example 45, did not prevent the agglomeration to occur

### Example #44

Pigment agglomeration is observed.

A liquid consisting of:

| Ingredient | Weight (%) |
|---|---|
| Water | 56.0 |
| Cyan pigment dispersion sold under the trade name | 7.5 |
| Hostafine Blue B2G manufactured by Clariant Corp. | Total solids = 3% |
| Resin solution sold under the trade name Joncryl | 36.5 |
| HPD671 manufactured by Johnson Polymer | Total solids = 10% |

was prepared in the following mixing order:

water

Hostafine Blue B2G

Joncryl HPD671

### Example #45

Pigment agglomeration is observed.

A liquid consisting of:

| Ingredient | Weight (%) |
|---|---|
| Water | 55.0 |
| Butylated polyvinylpyrrolidone sold under the trade | 1.0 |
| name Antaron P-904 manufactured by ISP | |
| Cyan pigment dispersion sold under the trade name | 7.5 |
| Hostafine Blue B2G manufactured by Clariant Corp. | Total solids = 3% |
| Resin solution sold under the trade name Joncryl | 36.5 |
| HPD671 manufactured by Johnson Polymer | Total solids = =10% |

was prepared in the following mixing order:

Antaron P-904

water

Hostafine Blue B2G

Joncryl HPD671

### Examples 46-47

In Example 46 the same resin solution used in Example 1 is added to a magenta pigment dispersion resulting in pigment agglomeration. Addition of Antaron-P904 (Example 47) at a concentration of 1% prior to the pigment dispersion and resin, prevent pigment agglomeration.

### Example #46

Pigment agglomeration is observed.

A liquid consisting of:

| Ingredient | Weight (%) |
|---|---|
| Water | 56.0 |
| Magenta pigment dispersion sold under the trade | 7.5 |
| name Hostafine Rubine F6B manufactured by | Total solids = 3% |
| Clariant Corp. | |
| Resin solution sold under the trade name Joncryl | 36.5 |
| HPD671 manufactured by Johnson Polymer | Total solids = 10% |

was prepared in the following mixing order:

Water

Hostaftine Rubine F6B

Joncryl HPD671

### Example #47

No pigment agglomeration.

A liquid consisting of:

| Ingredient | Weight (%) |
|---|---|
| Water | 55.0 |
| Butylated polyvinylpyrrolidone sold under the trade | 1.0 |
| name Antaron P-904 manufactured by ISP | |
| Magenta pigment dispersion sold under the trade | 7.5 |
| name Hostafine Rubine F6B manufactured by | Total solids = 3% |
| Clariant Corp. | |
| Resin solution sold under the trade name Joncryl | 36.5 |
| HPD671 manufactured by Johnson Polymer | Total solids = 10% |

was prepared in the following mixing order:

Antaron P-904

water

Hostafine Rubine F6B

Joncryl HPD671

### Examples 48-49

In Example 48 the same resin solution used in Example 1 is added to a yellow pigment dispersion resulting in pigment agglomeration. In Example 49 Antaron P904 is added at a concentration of 1% prior to the addition of pigment dispersion and resin. No pigment agglomeration is observed.

### Example #48

Pigment agglomeration is observed.

A liquid consisting of:

| Ingredient | Weight (%) |
|---|---|
| Water | 54.9 |
| Yellow pigment dispersion sold under the trade | 8.6 |
| name Hostafine Yellow HR manufactured by | Total solids = 3% |
| Clariant Corp. | |
| Resin solution sold under the trade name Joncryl | 36.5 |
| HPD671 manufactured by Johnson Polymer | Total solids = 10% |

was prepared in the following mixing order

Water

Hostafine Yellow HR

Joncryl HPD671

### Example #49

No pigment agglomeration.

A liquid consisting of:

| Ingredient | Weight (%) |
|---|---|
| Water | 53.9 |
| Butylated polyvinylpyrrolidone sold under the trade | 1.0 |
| name Antaron P-904 manufactured by ISP | |
| Yellow pigment dispersion sold under the trade | 8.6 |
| name Hostafine Yellow HR manufactured by | Total solids = 3% |
| Clariant Corp. | |
| Resin solution sold under the trade name Joncryl | 36.5 |
| HPD671 manufactured by Johnson Polymer | Total solids = 10% |

was prepared in the following mixing order:

Antaron P-904

Water

Hostafine Rubine F6B

Joncryl HPD671

### Examples 50-51

In Examples 50 and 51 the same resin solution used in Example 1 is added to a cyan pigment dispersion from a different manufacturer without and with Antaron P904. The sample to which Antaron P904 was added (Example 51) did not present pigment agglomeration whilst the sample without Antaron P904 (Example 50) presented pigment agglomeration.

### Example #50

Pigment agglomeration is observed.

A liquid consisting of:

| Ingredient | Weight (%) |
|---|---|
| Water | 42.1 |
| Cyan pigment dispersion sold under the trade name | 21.4 |
| Liojet Cyan K7088-A2 manufactured by Toyo Ink | Total solids = 3% |
| Resin solution sold under the trade name Joncryl | 36.5 |
| HPD671 manufactured by Johnson Polymer | Total solids = 10% |

was prepared in the following mixing order:

Water

Liojet Cyan K7088-A2

Joncryl HPD671

### Example #51

No pigment agglomeration.

A liquid consisting of:

| Ingredient | Weight (%) |
|---|---|
| Water | 41.1 |
| Butylated polyvinylpyrrolidone sold under the trade | 1.0 |
| name Antaron P-904 manufactured by ISP | |
| Cyan pigment dispersion sold under the trade name | 21.4 |
| Liojet Cyan K7088-A2 manufactured by Toyo Ink | Total solids = 3% |
| Resin solution sold under the trade name Joncryl | 36.5 |
| HPD671 manufactured by Johnson Polymer | Total solids = 10% |

was prepared in the following mixing order:

Antaron P-904

water

Liojet Cyan K7088-A2

Joncryl HPD671

### Example #52

In Example 52 the same resin solution used in Example 1 is added to a magenta pigment dispersion from a different manufacturer. Pigment agglomeration is not observed.

A liquid consisting of:

| Ingredient | Weight (%) |
|---|---|
| Water | 44.7 |
| Magenta pigment dispersion sold under the trade | 18.8 |
| name Liojet Magenta L4092 manufactured by Toyo | Total solids = 3% |
| Ink | |
| Resin solution sold under the trade name Joncryl | 36.5 |
| HPD671 manufactured by Johnson Polymer | Total solids = 10% |

was prepared in the following mixing order:

Water

Liojet Magenta L4092

Joncryl HPD671

### Example #53

In Example 53 the same resin solution used in Example 1 is added to a yellow pigment dispersion from a different manufacturer. Pigment agglomeration is not observed.

A liquid consisting of:

| Ingredient | Weight (%) |
|---|---|
| Water | 44.1 |
| Yellow pigment dispersion sold under the trade | 19.4 |
| name Liojet Yellow L2116-A1 manufactured by | Total solids = 3% |
| Toyo Ink | |
| Resin solution sold under the trade name Joncryl | 36.5 |
| HPD671 manufactured by Johnson Polymer | Total solids = 10% |

was prepared in the following mixing order:

Water

Liojet Yellow L2116-A1

Joncryl HPD671

### Examples 54-55

In Examples 54 and 55 the same resin solution used in Example 1 is added to a black pigment dispersion from a different manufacturer. In Example 55, Antaron P904 is added and no pigment agglomeration occurs. In Example 54 where no Antaron P904 is added, pigment agglomeration is observed.

### Example #54

Pigment agglomeration is observed.

A liquid consisting of:

| Ingredient | Weight (%) |
|---|---|
| Water | 44.1 |
| Black pigment dispersion sold under the trade name | 19.4 |
| Liojet Black 9122-A1 manufactured by Toyo Ink | Total solids = 3% |
| Resin solution sold under the trade name Joncryl | 36.5 |
| HPD671 manufactured by Johnson Polymer | Total solids = 10% |

was prepared in the following mixing order:

Water

Liojet black 9122-A1

Joncryl HPD671

### Example #55

No pigment agglomeration.

A liquid consisting of:

| Ingredient | Weight (%) |
|---|---|
| Water | 43.1 |
| Butylated polyvinylpyrrolidone sold under the trade | 1.0 |
| name Antaron P-904 manufactured by ISP | |
| Black pigment dispersion sold under the trade name | 19.4 |
| Liojet Black 9122-A1 manufactured by Toyo Ink | Total solids = 3% |
| Resin solution sold under the trade name Joncryl | 36.5 |
| HPD671 manufactured by Johnson Polymer | Total solids = 10% |

was prepared in the following mixing order:

Antaron P-904

Water

Liojet black 9122-A1

Joncryl HPD671

### Examples 56-58

Examples 56-58 describe the addition of the same resin solution used in Example 1 to colored pigment dispersions from Orient. No pigment agglomeration is observed in all of the examples.

### Example #56

A liquid consisting of:

| Ingredient | Weight (%) |
|---|---|
| Water | 48.5 |
| Cyan pigment dispersion sold under the trade name | 15.0 |
| Bonjet Cyan WMBE-6 manufactured by Orient | Total solids = 3% |
| Chemical Industries | |
| Resin solution sold under the trade name Joncryl | 36.5 |
| HPD671 manufactured by Johnson Polymer | Total solids = 10% |

was prepared in the following mixing order:

Water

Bonjet Cyan WMBE-6

Joncryl HPD671

### Example #57

A liquid consisting of:

| Ingredient | Weight (%) |
|---|---|
| Water | 50.1 |
| Magenta pigment dispersion sold under the trade | 13.4 |
| name Bonjet Magenta SMP-4-0302 manufactured by | Total solids = 3% |
| Orient Chemical Industries | |
| Resin solution sold under the trade name Joncryl | 36.5 |
| HPD671 manufactured by Johnson Polymer | Total solids = 10% |

was prepared in the following mixing order:

Water

Bonjet Magenta SMP4-0302

Joncryl HPD671

### Example #58

A liquid consisting of:

| Ingredient | Weight (%) |
|---|---|
| Water | 48.5 |
| Yellow pigment dispersion sold under the trade | 15.0 |
| name Bonjet Yellow WMYE-5 manufactured by | Total solids = 3% |
| Orient Chemical Industries | |
| Resin solution sold under the trade name Joncryl | 36.5 |
| HPD671 manufactured by Johnson Polymer | Total solids = 10% |

was prepared in the following mixing order:

Water

Bonjet Magenta SMP-4-0302

Joncryl HPD671

It will be appreciated that the present invention is not limited by what has been particularly shown and described hereinabove and that numerous modifications, all of which fall within the scope of the present invention, exist. For example, while the present invention has been described with respect to specific examples of polymer resins and pigment dispersions, it will be apparent to a person skilled in the art that this invention is not limited to the described polymer resins and pigment dispersions. Other resins and pigment dispersions from different manufacturers may be used, and these would still fall within the scope of this invention, Rather the scope of the invention is defined by the claims which follow:

What is claimed is:

1. A method of preventing pigment agglomeration upon the addition of an aqueous resin solution to an aqueous pigment dispersion, said method comprising the steps of:
mixing butylated PVP with said pigment dispersion; and
adding said resin solution to said mixture of butylated PVP and pigment dispersion;
thereby preventing pigment agglomeration.

2. The method according to claim 1, wherein said mixing step comprises the steps of:
preparing a water solution of butylated PVP; and
adding said pigment dispersion to said water solution.

3. The method according to claim 1, wherein said resin solution is an acrylic resin, a styrene acrylic resin, a carboxylated acrylic resin, or any combination thereof.

4. The method according to claim 1, wherein said pigment dispersion is a black pigment dispersion.

5. The method according to claim 1, wherein said pigment dispersion is a yellow pigment dispersion, a cyan pigment dispersion, or a magenta pigment dispersion.

6. The method according to claim 1, wherein the concentration of butylated PVP is 0.5-2% by weight.

7. The method according to claim 1, wherein the concentration of butylated PVP is 1% by weight.

8. The method according to claim 1, wherein the concentration of butylated PVP is 2% by weight.

9. A method of stabilizing an aqueous pigment dispersion upon the addition of an aqueous resin to said pigment dispersion, said method comprising the steps of:
mixing butylated PVP with said pigment dispersion; and
adding said resin solution to said mixture of butylated PVP and pigment dispersion;
thereby stabilizing said pigment dispersion.

10. The method according to claim 9, wherein said mixing step comprises the steps of:
preparing a water solution of butylated PVP; and
adding said pigment dispersion to said water solution.

11. The method according to claim 9, wherein said resin is an acrylic resin, a styrene acrylic resin, a carboxyiated acrylic resin, or any combination thereof.

12. The method according to claim 9, wherein said pigment dispersion is a black pigment dispersion.

13. The method according to claim 9, wherein said pigment dispersion is a yellow pigment dispersion, a cyan pigment dispersion, or a magenta pigment dispersion.

14. The method according to claim 9, wherein the concentration of butylated PVP is 0.5-2% by weight.

15. The method according to claim 9, wherein the concentration of butylated PVP is 1% by weight.

16. The method according to claim 9, wherein the concentration of butylated PVP is 2% by weight.

17. A process for preparing an aqueous pigment-based ink, said process comprising the steps of:
preparing a water solution of butylated PVP;
adding a humectant to said water solution;
adding an aqueous pigment dispersion to said water solution, thereby preparing a mixture of said butylated PVP and said pigment dispersion; and
adding an aqueous resin solution to said mixture of butylated PVP and pigment dispersion,
thereby preparing said aqueous pigment-based ink.

18. The process according to claim 17, further comprising the step of adding a reagent for preventing bacterial growth.

19. The process according to claim 17, further comprising the step of adding a surfactant.

20. The process according to claim 17, wherein said resin is an acrylic resin, a styrene acrylic resin, a carboxylated acrylic resin, or any combination thereof.

21. The process according to claim 17, wherein said pigment dispersion is a black pigment dispersion.

22. The process according to claim 17, wherein said pigment dispersion is a yellow pigment dispersion, a cyan pigment dispersion, or a magenta pigment dispersion.

23. The process according to claim 17, wherein the concentration of butylated PVP is 0.5-2% by weight.

24. The process according to claim 17, wherein the concentration of butylated PVP is 1% by weight.

25. The process according to claim 17, wherein the concentration of butylated PVP is 2% by weight.

26. An aqueous ink composition for use in ink-jet printing, said composition comprising:
water;
butylated PVP;
an aqueous pigment dispersion;
a resin; and
a humectant.

27. The composition according to claim 26, further comprising a reagent for preventing bacterial growth.

28. The composition according to claim 26, further comprising a surfactant.

29. The composition according to claim 26, wherein said resin is an acrylic resin, a styrene acrylic resin, a carboxylated acrylic resin, or any combination thereof.

30. The composition according to claim 26, wherein said pigment dispersion is a black pigment dispersion.

31. The composition according to claim 26, wherein said pigment dispersion is a yellow pigment dispersion, a cyan pigment dispersion, or a magenta pigment dispersion.

32. The composition according to claim 26, wherein the concentration of butylated PVP is 0.5 2% by weight.

33. The composition according to claim 26, wherein the concentration of butylated PVP is 1% by weight.

34. The composition according to claim 26, wherein the concentration of butylated PVP is 2% by weight.
